(19) United States
(12) Patent Application Publication
(10) Pub. No.: US 2015/0220559 A1
(43) Pub. Date: Aug. 6, 2015

(54) Scalable File System

(71) Applicants: Kurichiyath Sudheer, Banaglore Karnataka (IN); Gowda Kiran, Bangalore KA (IN); Rajgaria Punit, Banaglore Karnataka (IN)

(72) Inventors: Kurichiyath Sudheer, Banaglore Karnataka (IN); Gowda Kiran, Bangalore KA (IN); Rajgaria Punit, Banaglore Karnataka (IN)

(21) Appl. No.: 14/414,958

(22) PCT Filed: Sep. 6, 2012
(86) PCT No.: PCT/IN2012/000589

§ 371 Date: Jan. 15, 2015

(51) Int. Cl. G06F 17/30

(52) U.S. Cl. CPC G06F 17/30194; G06F 17/30171

(57) ABSTRACT

A scalable file system by performing logical and/or physical splitting of one or more file systems is disclosed. In one example, lock statistics associated with each file system in each node in a storage pool clustered domain are obtained from a distributed lock manager. Further, one or more file systems associated with one or more nodes in the storage pool clustered domain are broken into one or more child file systems based on the obtained lock statistics and assigned ownerships to the one or more nodes in a cluster.

### BACKGROUND

Scalability of a file system is an important requirement in storage systems. This is especially crucial when handling storage bursts in the storage systems. Typically, such storage bursts are handled by over provisioning storage capacity and controllers. Such over provisioning may lead to wastage of unused storage spaces and additional costs to power the cooling needs of the storage controllers.

### BRIEF DESCRIPTION OF THE DRAWINGS

Examples of the present techniques will now be described in detail with reference to the accompanying drawings, in which:

FIG. 1 illustrates an example block diagram of a scalable file system in a coarse grained clustered storage domain environment;

FIG. 2 illustrates another example block diagram of the scalable file system in a fine grained clustered storage domain environment;

FIG. 3 illustrates an example block diagram of creating a virtual root by performing a logical splitting of one or more file systems;

FIG. 4 illustrates an example block diagram of creating multiple separately mountable file systems each having respective root tags by performing physical splitting of the one or more file systems; and

FIG. 5 illustrates an example flowchart of a method for dynamically creating the scalable file system in a clustered storage domain environment, such as those shown in FIGS. 1-4.

The drawings described herein are for illustration purposes only and are not intended to limit the scope of the present disclosure in any way.

### DETAILED DESCRIPTION

A scalable file system is disclosed. In the following detailed description of the examples of the present subject matter, references are made to the accompanying drawings that form a part hereof, and in which are shown by way of illustration specific examples in which the present subject matter may be practiced. These examples are described in sufficient detail to enable those skilled in the art to practice the present subject matter, and it is to be understood that other examples may be utilized and that changes may be made without departing from the scope of the present subject matter. The following detailed description is, therefore, not to be taken in a limiting sense, and the scope of the present subject matter is defined by the appended claims.

Further, the terms “nodes” and “controllers” are used interchangeably throughout the document. Furthermore, the terms “forking” and “splitting” are used interchangeably throughout the document.

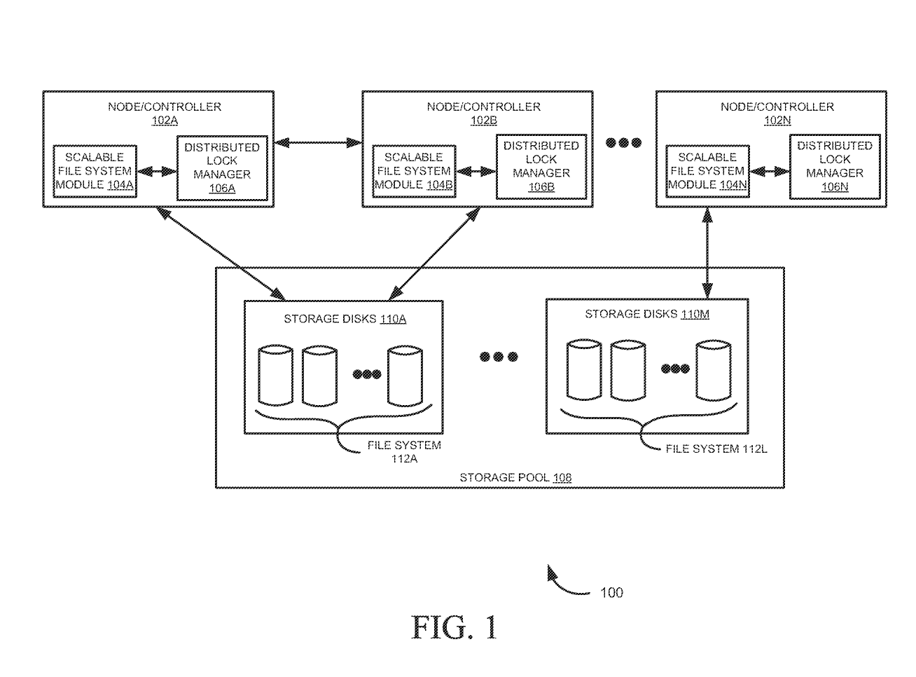

FIG. 1 illustrates an example block diagram 100 of a scalable file system in a coarse grained clustered storage domain environment. As shown in FIG. 1, the scalable file system includes a plurality of nodes/controllers 102A-102N and a storage pool 108. Further as shown in FIG. 1, each of the nodes/controllers 102A-102N includes an associated one of the scalable file system modules 104A-104N and distributed lock managers (DLMs) 106A-106N. The storage pool 108 includes storage disks 110A-110M. Furthermore as shown in FIG. 1, the storage disks 110A-110M include file systems 112A-112L. In addition as shown in FIG. 1, the nodes/controllers 102A-102N are communicatively coupled to each other. Further, the scalable file system modules 104A-104N and the DLMs 106A-106N are communicatively coupled in each of the nodes/controllers 102A-102N as shown in FIG. 1. Additionally as shown in FIG. 1, the nodes/controllers 102A-102N are communicatively coupled to the storage disks 110A-110M to access the file systems 112A-112L in the storage disks 110A-110M, respectively. For example, the node/controller 102A and the node/controller 102B are communicatively coupled to the storage disks 110A to access the file system 112A. In the coarse grained clustered storage domain environment, the file systems 112A-L are created by partitioning the storage disks 110A-110M at disk level. In an exemplary scenario, the node/controller 102A and the node/controller 102B access the file system 112A hosted by the storage disks 110A, as the storage disks 110 OA-110M are partitioned at disk level. In operation, the nodes/controllers 102A-102N create one or more separately mountable file systems in the storage pool 108.

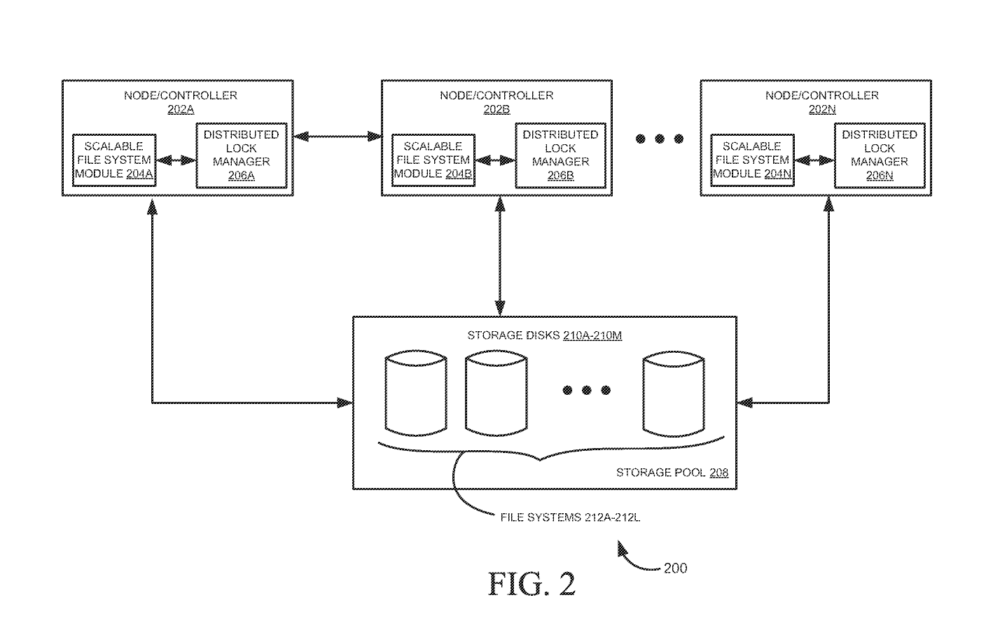

Referring now to FIG. 2, which is an example block diagram 200 illustrating the scalable file system in a fine grained clustered storage domain environment. As shown in FIG. 2, the scalable file system includes a plurality of nodes/controllers 202A-202N and a storage pool 208. Further as shown in FIG. 2, the nodes/controllers 202A-202N include associated scalable file system modules 204A-204N and distributed lock managers (DLMs) 206A-206N, respectively. The storage pool 208 includes a plurality of storage disks 210A-210M. The storage disks 210A-210M include one or more file systems 212A-212L. Furthermore as shown in FIG. 2, the nodes/controllers 202A-202N are communicatively coupled to each other and the storage pool 208. Further, the scalable file system modules 204A-204N and the DLMs 206A-206N are communicatively coupled as shown in FIG. 2. In the fine grained clustered storage domain environment, such as shown in FIG. 2, the file systems 212A-212L are created by partitioning the storage disks 210A-210M logically at block level. Also, the file systems 212A-212L are distributed across the storage disks 210A-210M as the storage disks 210A-210M are partitioned at block level.

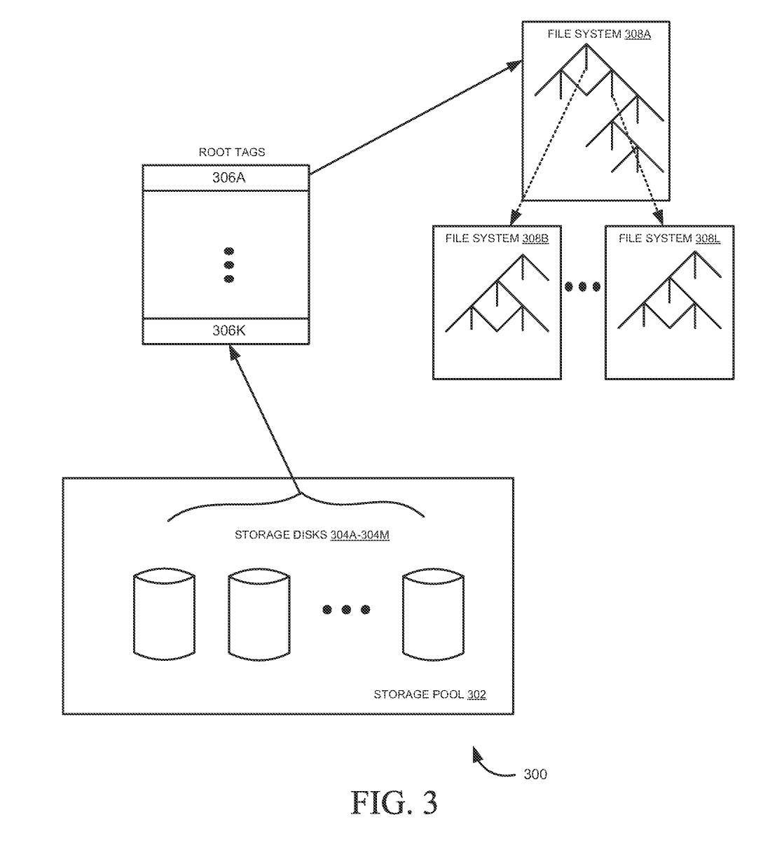

Referring now to FIG. 3, which is an example block diagram 300 illustrating creation of a virtual root by performing a logical splitting of one or more file systems. As shown in FIG. 3, the block diagram 300 includes the storage pool 302 having a plurality of storage disks 304A-304M. The storage pool 302 is served by one or more nodes/controllers (such as nodes/controllers 102A-102N shown in FIG. 1 or nodes/controllers 202A-202N shown in FIG. 2) which include associated scalable file system modules (such as scalable file system modules 104A-104N shown in FIG. 1 or scalable file system modules 204A-204N shown in FIG. 2) and distributed lock managers (DLMs) (such as DLMs 106A-106N shown in FIG. 1 or DLMs 206A-206N shown in FIG. 2). Each of the scalable file system modules obtains one or more lock statistics associated with each of the file systems 308A-308L from the DLMs. Furthermore, the storage disks 304A-304M include one or more file systems, such as file system 308A. Additionally, the storage pool 302 also maintains root tags 306A-306K pointing to a root directory of the one or more file systems 308A-308L. Further, the nodes/controllers create a plurality of separately mountable file systems in the storage pool 302.

In an exemplary scenario, if a node/controller associated with the file system 308A receives increased number of input/output (I/O) requests to access the file system 308A, then the node/controller may fail to handle the I/O requests due to excessive conflicting lock requests, i.e., excessive requests to a same lock by multiple nodes and/or controllers, which can lead to cache invalidations in one or more nodes. Each cache invalidation may result in the disk input/outputs, i.e., both writes and reads. For example, the writes can happen in the node that had modified contents in the cache, which has to be written back to disk and the reads may happen in the nodes that need fresh data from the disk. In this case, the scalable file system module in the associated node/controller obtains lock statistics of all the file systems in the storage pool 302 from the DLMs. The lock statistics are obtained from the statistics maintained in the DLMs, such as, node/controller affinities, access patterns of nodes/controllers, node/controller central processing unit (CPU) utilization and so on. In an example scenario, the scalable file system module periodically obtains the statistics maintained by the DLMs.

Upon obtaining the lock statistics of the file systems, the scalable file system module identifies the file system 308A demanding for surplus resources and performs the logical splitting of the file system 308A into one or more child file systems such as file systems 308B-308L. Further, the file system 308A is a virtual root to the child file systems 308B-308L. A root tag 306A is allocated for the file system 304A in order to identify the file system 308A across the file systems in the storage pool 302. Further, the root tag 306A is allocated to the file system 308A at a storage pool level to avoid contention during root tag allocation. Furthermore, the root tag 306A points to a root directory of the file system 308A which in turn leads to a namespace of the file system 308A. In an example, the child file systems 308B-308L are accessible via the virtual root (file system 304A).

Further, the scalable file system module obtains access patterns of each node/controller from the respective DLMs. The access pattern associated with locking is a number of times a node has called a lock and unlock request in a shared and exclusive mode. In the event of a tie among different nodes, the number of exclusive lock requests made is used for breaking a tie. Furthermore, the scalable file system module identifies one or more nodes/controllers that are capable of hosting one or more file systems. Additionally, when the logical splitting is performed on the virtual root (file system 308A), ownership of the virtual root is divided among the identified nodes/controllers. In other words, the child file systems created from the virtual root are deployed on the identified nodes/controllers.

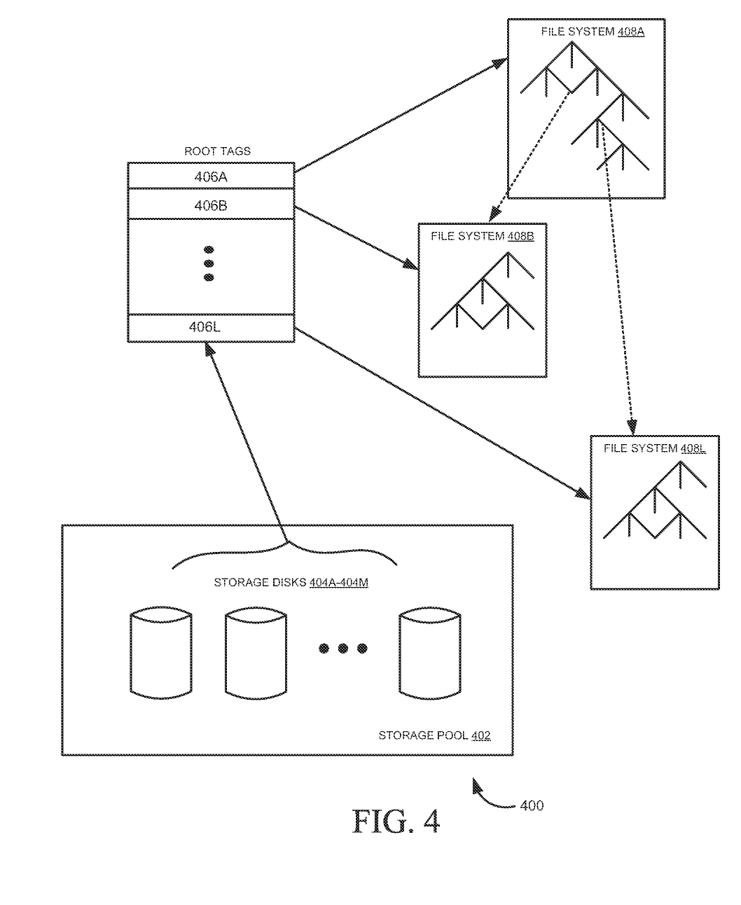

Referring now to FIG. 4, which is an example block diagram 400 illustrating creation of multiple separately mountable file systems each having respective root tags by performing a physical splitting of the one or more file systems. As shown in FIG. 4, the block diagram 400 includes the storage pool 402. The storage pool 402 includes the plurality of storage disks 404A-404M. The storage pool 402 is served by one or more nodes/controllers (such as the nodes/controllers 102A-102N or nodes/controllers 202A-202N shown in FIG. 2) which include associated scalable file system modules (such as the scalable file system modules 104A-104N shown in FIG. 1 or scalable file system modules 204A-204N shown in FIG. 2) and distributed lock managers (DLMs) (such as, DLMs 106A-106N shown in FIG. 1 or DLMs 206A-206N shown in FIG. 2). Each of the scalable file system modules obtains one or more lock statistics associated with each of the file systems 408A-408L from the associated DLMs. Additionally, the storage disks 404A-404M includes one or more file systems, such as the file system 408A. Further, the storage pool 402 also maintains root tags 406A-406L pointing to a root directory of the one or more file systems. Further, the nodes/controllers create multiple separately mountable file systems in the storage pool 402.

In an exemplary scenario, if a node/controller associated with the file system 408A receives increased number of I/O requests for accessing the file system 408A, then the node/controller may fail to handle the I/O requests due to excessive conflicting lock requests. In this case, the scalable file system module in the associated node/controller obtains lock statistics of all the file systems in the storage pool 402 from the associated DLM. The lock statistics are obtained from the statistics maintained in the DLM such as, node/controller affinities, access patterns of nodes/controllers, node/controller CPU utilization and so on. In an exemplary scenario, the scalable file system module periodically obtains the statistics maintained by the DLMs.

Upon obtaining the lock statistics of the file systems, the scalable file system module identifies the file system 408A demanding for surplus resources and performs the physical splitting of the file system 408A into one or more child file systems, such as file systems 408B-408L. In an example, the one or more child file systems are separately mountable file systems. The file system 408A serves as a root file system for the child file systems 408B-408L. The root tags are allocated for all the file systems involved in the physical splitting. For example, the root tag 406A is allocated to the root file system 408A, the root tag 406B is allocated to the child file system 408B and so on, as shown in FIG. 4. Further, the root tags 406A-406L may be assigned to identify the file systems 408A-408L in the storage pool 402. Furthermore, the root tags 406A-406L point to root directories of the file systems 408A-408L which in turn leads to namespaces of the file systems 408A-408L.

Further, the scalable file system module obtains access patterns of each node/controller from the respective DLMs. Furthermore, the one or more nodes/controllers that are capable of hosting file systems are identified. Additionally, during the physical splitting, the root file system (file system 408A) and the child file systems (408B-408L) created from the root file system are deployed on the identified controllers/nodes. Furthermore, the child file systems 408B-408L are accessible through the root file system as well as the associated child file systems as shown in FIG. 4.

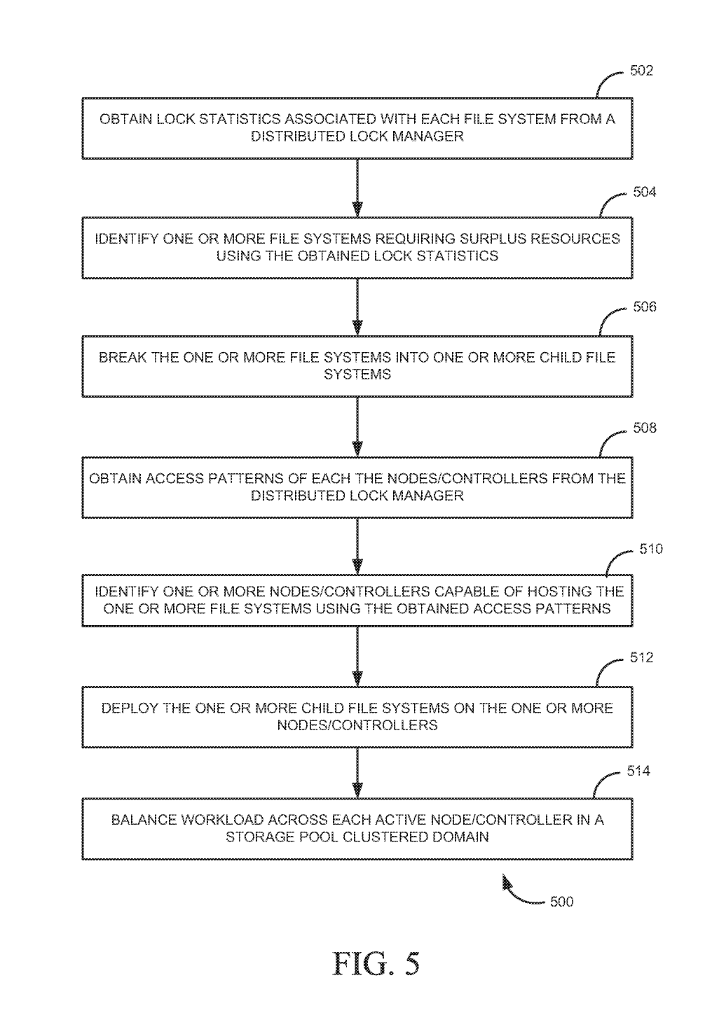

Referring now to FIG. 5, which is an example flowchart 500 illustrating a method for dynamically creating the scalable file system in a clustered storage domain environment, such as those shown in FIGS. 1˜4. The clustered storage domain includes one of a coarse grained clustered storage domain (as explained in FIG. 1), a fine grained clustered storage domain (as explained in FIG. 2) and the like. At step 502, lock statistics associated with each file system in each node/controller in a storage pool clustered domain are obtained from a distributed lock manager (DLM). The lock statistics are obtained from the statistics maintained in the DLM such as, node/controller affinities, access patterns of nodes/controllers, node/controller CPU utilization and so on. At step 504, one or more file systems requiring surplus resources are identified using the obtained lock statistics.

At step 506, the one or more file systems associated with the one or more nodes/controllers in the storage pool clustered domain are broken into one or more child file systems based on the obtained lock statistics and assigned ownerships to the one or more nodes in a cluster. Further, breaking the file systems into the one or more child file systems includes logical splitting or physical splitting of the identified file systems. When the one or more file systems are split using the logical splitting, a virtual root is created and the ownership of the virtual root is divided logically among one or more of the controllers/nodes in the storage pool. In case the one or more file systems are split using physical splitting, the one or more child file systems are created such that each file system is accessible from a root file system and the one or more child file systems. Please refer to FIGS. 3 and 4 for detailed explanation of logical splitting and physical splitting, respectively. In one example, the one or more file systems in one or more nodes/controllers are broken dynamically into the one or more child file systems. In another example, an information technology (IT) administrator manually creates forked child file systems for one or more file systems in the storage pool clustered domain based on the obtained lock statistics.

At step 508, access patterns of each the nodes/controllers in the storage pool clustered domain are obtained from the DLMs. At step 510, one or more nodes/controllers capable of accommodating/hosting the one or more file systems are identified using the obtained access patterns. At step 512, the one or more child file systems (generated by logical or physical splitting) are deployed on the one or more identified nodes/controllers based on the obtained access patterns.

At step 514, workload across each active node/controller in the storage pool clustered domain is balanced based on the obtained lock statistics and/or access patterns. The workload includes, for example, the number of file systems that the node/controller is handling. Workload balancing includes assigning file systems to the nodes/controllers based on the level of workload that the nodes/controllers are bearing. For example, if the node/controller has reached a maximum threshold of performance, one or more file systems in the node/controller that are demanding surplus resources are split logically or physically (as explained in FIGS. 3 and 4) into child file systems and deployed on other nodes/controllers that are handling relatively smaller or no load. In some examples, the workload of the node/controller is determined using the statistics maintained in the DLM. Further, if a load in a child file system in the node/controller is reduced and not demanding any surplus resources, then the child file system is merged with a parent file system from which the child file system originated and shifted to another node/controller based on the access patterns obtained from the DLM. Therefore, the method performs elastic workload balancing between the nodes/controllers.

For example, the scalable file system module (such as scalable file system modules 104A-104N shown in FIG. 1 or scalable file system modules 204A-204N shown in FIG. 2) described above may be in the form of instructions stored on a non transitory computer readable storage medium. An article includes the non transitory computer readable storage medium having the instructions that, when executed by the nodes/controllers (such as nodes/controllers 102A-102N shown in FIG. 1 or nodes/controllers 202A-202N shown in FIG. 2), causes the scalable file system to perform the one or more methods described in FIGS. 1-5.

In various examples, system and method described in FIGS. 1-5 propose a technique for the scalable file system in a storage environment. The technique splits the file system demanding surplus resources into smaller file systems and assigns the smaller file systems to one or more nodes/controllers serving the storage pool. The technique obviates the need for over provisioning resources to cater I/O bursts experienced by the file systems. The physical and logical splitting of file system divide the file system while maintaining a single namespace. The technique also performs intelligent load sharing between the nodes/controllers serving the storage pool using the statistics available in the DLM.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A method for scalable file systems, comprising:
obtaining lock statistics associated with each file system in each node in a storage pool clustered domain from a distributed lock manager; and
breaking one or more file systems associated with one or more nodes in the storage pool clustered domain into one or more child file systems based on the obtained lock statistics and assigned ownerships to the one or more nodes in a cluster.

2. The method of claim 1, further comprising:
obtaining access patterns associated with each node in the storage pool clustered domain from the distributed lock manager; and
deploying the one or more child file systems on the one or more nodes based on the obtained access patterns.

3. The method of claim 2, further comprising:
identifying the one or more nodes capable of hosting the one or more child file systems using the obtained access patterns.

4. The method of claim 2, further comprising:
balancing workload across each node in the storage pool clustered domain based on the obtained lock statistics and/or access patterns.

5. The method of claim 1, wherein the lock statistics are selected from a group consisting of node affinities and central processing unit (CPU) utilization of the node.

6. The method of claim 1, further comprising:
identifying the one or more file systems demanding surplus resources using the obtained lock statistics.

7. The method of claim 1, wherein the storage pool clustered domain comprises a coarse grained clustered domain and/or a fine grained clustered domain.

8. The method of claim 1, wherein breaking the one or more file systems into the one or more child file systems comprises logical splitting of the one or more file systems and/or physical splitting of the one or more file systems.

9. The method of claim 8, wherein the logical splitting of the one or more file systems comprises creating a virtual root and wherein ownership of the virtual root is divided logically among one or more of the nodes in the storage pool.

10. The method of claim 8, wherein the physical splitting of the one or more file systems comprises creation of the one or more child file systems such that each file system is accessible from a root file system and the one or more child file systems.

11. The method of claim 1, wherein breaking the one or more file systems in the one or more nodes in the storage pool clustered domain into the one or more child file systems based on the obtained lock statistics comprises:
dynamically breaking the one or more file systems in the one or more nodes in the storage pool clustered domain based on the obtained lock statistics.

12. The method of claim 1, wherein breaking the one or more file systems in the one or more nodes in the storage pool clustered domain into the one or more child file systems based on the obtained lock statistics comprises:
manually creating the one or more child file systems for the one or more file systems in the one or more nodes in the storage pool clustered domain based on the obtained lock statistics.

13. A scalable file system, comprising:
one or more nodes communicatively coupled to each other; and
one or more storage devices communicatively coupled to the one or more nodes, wherein each node comprises:
a processor; and
a memory coupled to the processor, wherein the memory comprising a scalable file system module configured to:
obtain lock statistics associated with each file system in each node in a storage pool clustered domain using a distributed lock manager; and
break one or more file systems in one or more nodes in the storage pool clustered domain into one or more child file systems based on the obtained lock statistics and assigned ownerships to the one or more nodes in a cluster.

14. The system of claim 13, wherein the scalable file system module is further configured to:
obtain access patterns associated with each node in the storage pool clustered domain from the distributed lock manager; and
deploy the one or more child file systems on the one or more nodes based on the obtained access patterns.

15. A non-transitory computer-readable storage medium having instructions that when executed by a computing device, cause the computing device to:
obtain lock statistics associated with each file system in each node in a storage pool clustered domain from a distributed lock manager; and
break one or more file systems associated with one or more nodes in the storage pool clustered domain into one or more child file systems based on the obtained lock statistics and assigned ownerships to the one or more nodes in a cluster.
